(19) United States
(12) Patent Application Publication
(10) Pub. No.: US 2005/0226767 A1
(43) Pub. Date: Oct. 13, 2005

(54) Device for determing and displaying at least one physical, chemical or biological property of a test liquid

(76) Inventor: Hartmut Klocke, Karlsruhe (DE)

Correspondence Address: BROWDY AND NEIMARK, P.L.L.C.;624 NINTH STREET, NW, SUITE 300, WASHINGTON, DC, 20001-5303, US

(21) Appl. No.: 10/511,827

(22) PCT Filed: Sep. 23, 2003
(86) PCT No.: PCT/DE03/03153

§ 371 Date: Oct. 20, 2004

(30) Foreign Application Priority Data
Sep. 27, 2002 (DE) 20214971.4

(51) Int. Cl. G01N 31/22

(52) U.S. Cl. 422/58

(57) ABSTRACT

A device for determining and displaying at least one physical, chemical or biological property of a test liquid or for detecting substances and/or organisms contained therein by reaction with at least one indicator or reactant. The indicator(s) (2.0) is/are can be accessed in or via at least one reaction chamber (1.5) provided with at least one inlet for the test fluid. Said device is embodied in the form of a deep-drawn cup-shaped element (1.1) which is scaled by a covering film (1.2). The shape and/or material properties of the reaction chamber(s) is/are preferably selected in such a way that a reset effect is created after deformation such that the original shape can be restored by creating an absorption effect until the original volume is substantially re-created.

### FIELD OF THE INVENTION

The invention relates to a device for determining and displaying at least one physical, chemical, or biological property of a stamped-out feature, or for detecting substances and/or organisms contained therein by reaction with at least one indicator or reactant.

The test liquid of particular interest here is water, along with its physical and chemical properties and its ingredients, that is, substances or combinations thereof that are as a rule contained in water, either intentionally as additives or unintentionally as contaminants.

Water is used in the most manifold ways, as a fundamental nutrient, in industry, but also increasingly in the recreational field. Being an element necessary for life, water is one of our most important resources. Environmental factors have an ever-increasing influence on the quality of our water. To lend the water or other liquids certain properties, such as protection against bacterial contamination or a change in its degrees of hardness, it is necessary to add certain additives to the water. Excessively high concentrations of additives can be harmful or even be toxic to some organisms.

To prevent major damage to humans, the environment, and material, a constant detection of certain ingredients or microorganisms and their concentration in water and other liquids must be performed. The methods for detection must be reliable, simple to handle, and replicable.

### BACKGROUND OF THE INVENTION

In general, the detection is performed by means of an indicator, which when put together with the medium (test liquid) to be tested leads to certain reactions, such as a change of color. In many cases, the liquid to be tested must first be withdrawn from a larger container and then put together with the indicator in a certain volumetric ratio. From a separate comparison panel, such as a color palette, the ingredients and their concentration are then ascertained.

### DESCRIPTION OF THE INVENTION

The invention is intended to make this detection simpler. This object is attained by means of the provisions of the body of claim 1.

A fundamental concept of the invention is considered to be that the test liquid can be withdrawn without the aid of an intermediate holder and reacts with the indicator in the reaction chamber.

In an especially preferred feature, the fundamental construction of the reaction chamber in which the detection is performed comprises a thermoplastic bottom film, which is deformed into a deep-drawn cup-shaped element, with a covering film sealed onto it and contains the indicator required for the detection, which before activation is protected against such external factors as moisture. An information-carrying medium required for the detection, for instance in the form of a comparison strip, is preferably placed directly on the device or in a separate chamber. With this simple embodiment, the known technology for producing deep-drawn packages and blister packs can be equipped and used for the intended purpose.

Other preferred features can be learned from other dependent claims.

### BRIEF DESCRIPTION OF THE DRAWINGS

A plurality of exemplary embodiments will be described in further detail in conjunction with drawings, which show:

FIG. 1: an elevation view and section of the first exemplary embodiment;

FIG. 2: a first exemplary embodiment in perspective;

FIG. 3: the manipulation of the first exemplary embodiment;

FIG. 4: a second exemplary embodiment of the device of the invention;

FIG. 5: a third exemplary embodiment of the device of the invention in a front view and in section;

FIG. 6: the manipulation of the third exemplary embodiment.

FIG. 7: a fourth exemplary embodiment in a front view and in section and in the activated state;

FIG. 8: a fifth exemplary embodiment;

FIG. 9: a sixth exemplary embodiment;

FIG. 10: the manipulation of the sixth exemplary embodiment;

FIG. 11: (missing)

FIG. 12: a seventh exemplary embodiment with two chambers;

FIG. 13: the manipulation of the seventh exemplary embodiment;

FIG. 14: an eighth exemplary embodiment;

FIG. 15: the manipulation of the eighth exemplary embodiment;

FIG. 16: a ninth exemplary embodiment;

FIG. 19: a twelfth exemplary embodiment;

FIG. 20: a thirteenth exemplary embodiment;

FIG. 21: the manipulation of the thirteenth exemplary embodiment;

FIG. 22: possible ways of hanging up the device of the invention;

FIG. 23: a first way of standing up the device of the invention;

FIG. 24: a second way of standing up the device of the invention;

FIG. 25: a third way of standing up the device of the invention;

FIG. 26: a first variant of the aspiration opening without a rated breaking point; and

FIG. 27: a second variant of the aspiration opening without a rated breaking point.

### DESCRIPTION OF THE EXEMPLARY EMBODIMENTS

FIG. 1 shows a first exemplary embodiment of the device of the invention, which for the sake of simplicity will hereinafter be called a liquid tester. The liquid tester 1.0, in its basic construction, comprises a bottom film, which is deformed thermoplastically into a deep-drawn cup-shaped element 1.1, and a covering film 1.2 sealed onto it and thus forms a deep-drawn package. The deep-drawn cup-shaped element 1.1 is tapered on one end to form a breakaway tip 1.3, which serves the purpose of later withdrawal of the test liquid, and is separated from the rest of the deep-drawn package by a rated breaking point (crease) 1.4. Between the deep-drawn cup-shaped element 1.1 and covering film 1.2, a reaction chamber 1.5 for receiving the test liquid is thus formed, and in a region 1.5.1 it is designed such that after deformation, by the interplay of its shaping and the choice of material, it resumes its original form again and thus a pump mechanism is created in which, when the deformed deep-drawn cup-shaped element 1.1 resumes its original form a negative pressure builds up, thus causing suction on the inlet opening 1.9 after the breakaway tip 1.3 has been broken off.

On the opposite side of the breakaway tip 1.3, a striplike indicator 2.0 is placed in a separate indicator chamber 1.6; this indicator can be equipped with one or more reactants or saturated with them. The indicator chamber 1.6 communicates with the reaction chamber 1.5 or forms a part of it, so that the test liquid can come into contact with the indicator 2.0.

A marking 1.7 makes it possible to tell what the aspirated volume of test liquid is. It can be made as a deep-drawn marking or embossing in the bottom film or applied in printed form on the deep-drawn cup-shaped element 1.1 and/or on the covering film 1.2.

At a suitable point, one or more information-carrying media are applied to the liquid tester 1.0 in the form of comparison scales taking the form of a color palette 1.8. The color palette may be in form of a printed inscription or a label. The comparison scales described and the volumetric markings can be used in all the exemplary embodiments that follow and will therefore not be mentioned again there.

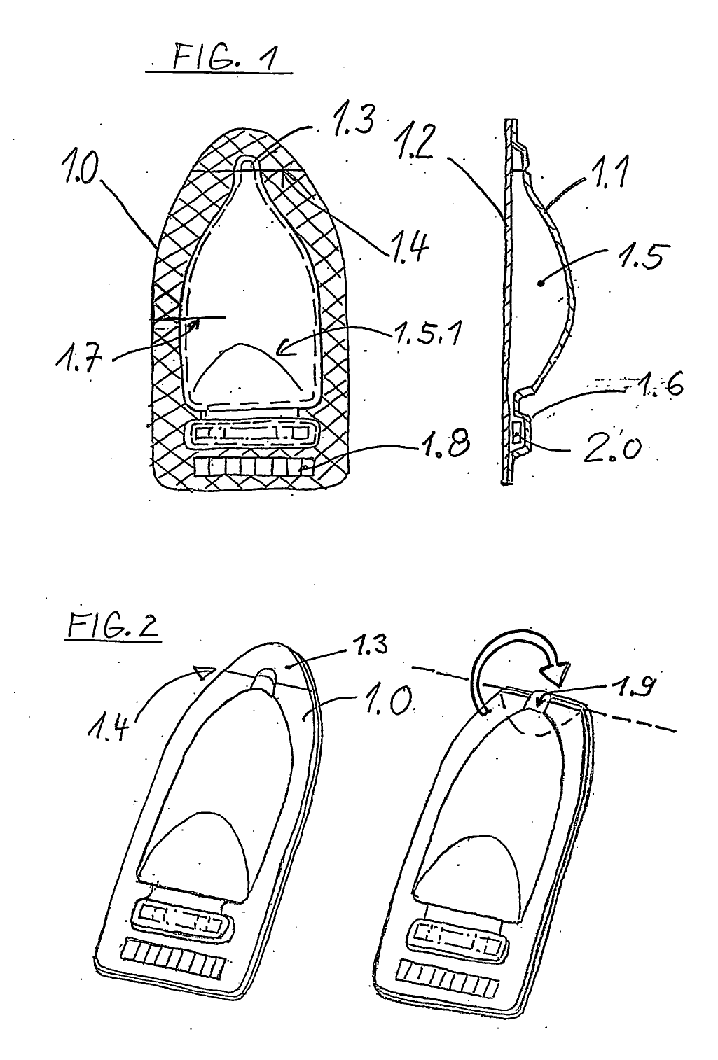

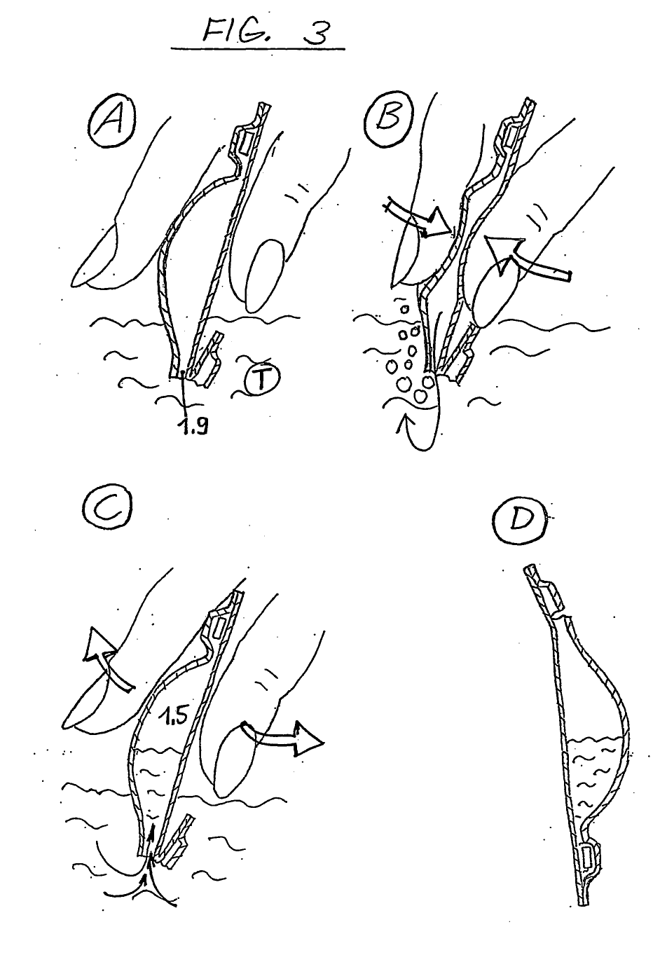

FIG. 2 shows the liquid tester 1.0 in perspective. For activating the liquid tester 1.0, it is broken open along its rated breaking point 1.4, thus exposing the inlet opening 1.9 for the test liquid.

FIG. 3 shows the various phases of withdrawing the test liquid T:
A: The inlet opening 1.9 of the liquid tester 1.0 is kept below the level of the surface of the test liquid T.
B: By pressure on the reaction chamber 1.5, the air is made to escape from the liquid tester 1.0.
C: With the relief of the reaction chamber 1.5, the test liquid is aspirated into the reaction chamber 1.5.
D: Once the liquid tester 1.0 is inverted, the indicator 2.0 is bathed by the test liquid and reacts with it, and as a result a coloration ensues, for instance, that can be compared with the colors on the comparison scale.

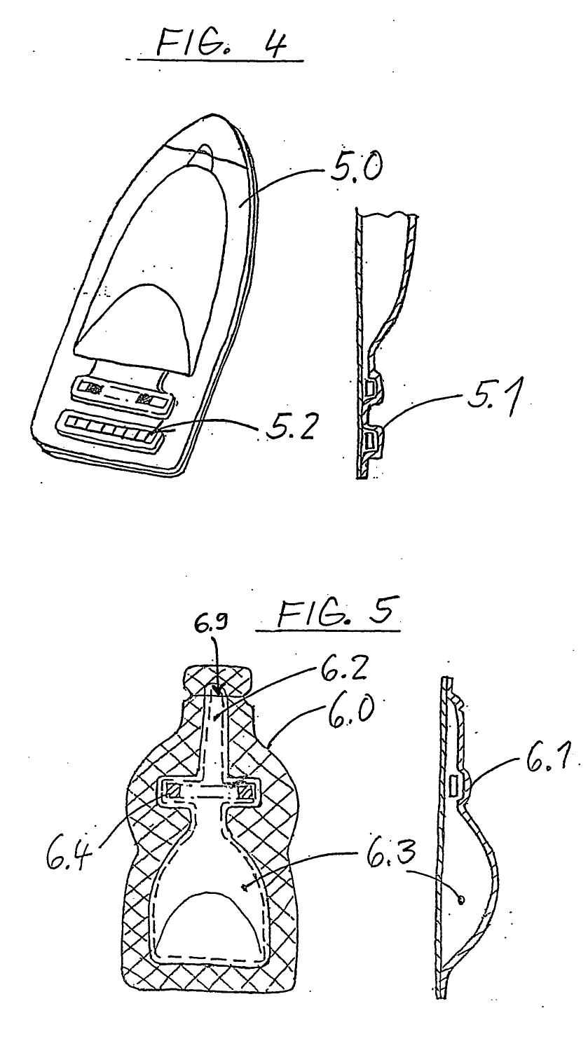

FIG. 4 shows a second exemplary embodiment, the liquid tester 5.0. Its fundamental structure is identical to the liquid tester 1.0 and will not be described in further detail.

At a suitable point, one or more deep-drawn cup-shaped elements 5.1 are provided as indicator chambers, which are demarcated from the other chambers and can receive an indicator 5.2 in the form of a comparison strip of arbitrary shape.

FIG. 5 shows a third exemplary embodiment, the liquid tester 6.0. The fundamental structure of the liquid tester 6.0 is identical to the liquid tester 1.0 and will not be described in further detail.

The indicator chamber 6.1 that receives the indicator 6.4 is disposed between the inlet opening 6.9 and the reaction chamber 6.3 in the region of the lengthened breakaway tip 6.2, so that in use, the indicator 6.4 is at first bathed by the test liquid, but does not remain in the test liquid, once the liquid tester 6.0 has been rotated approximately 1800.

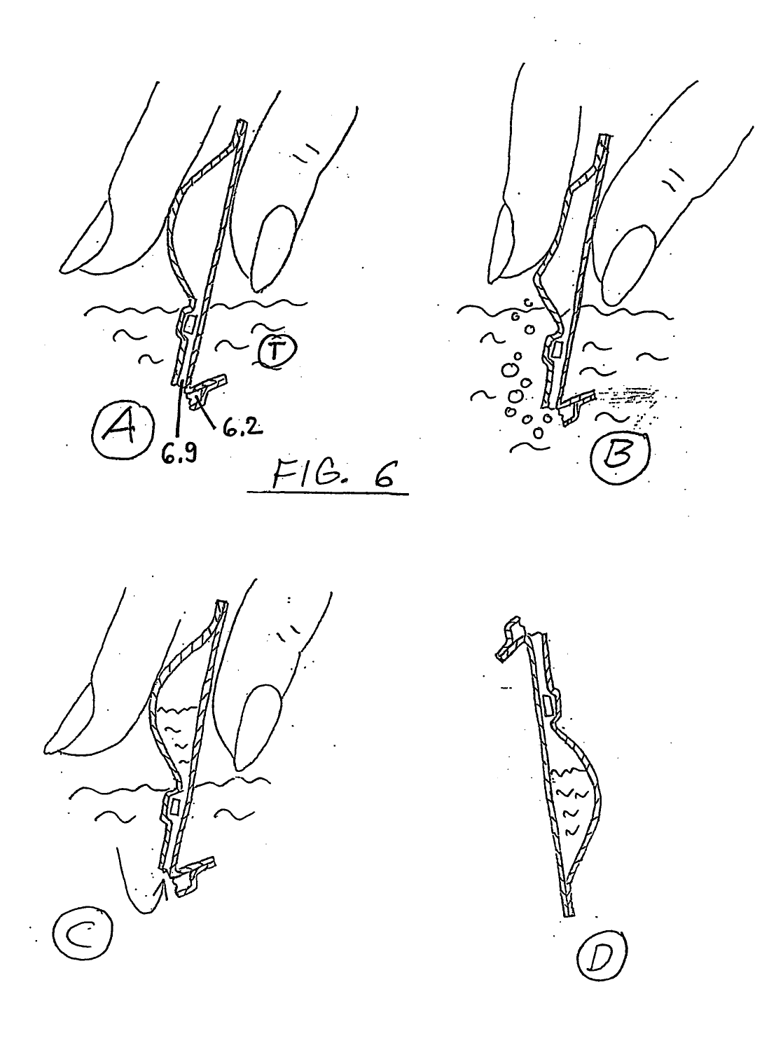

FIG. 6 shows the liquid tester 6.0 in the various phases of its use.
A: The opened breakaway tip 6.2 and thus the inlet opening 6.9 of the liquid tester 6.0 are kept below the level of the liquid.
B: By pressure on the reaction chamber 6.3, air is made able to escape from the liquid tester 6.0.
C: With the relief of the reaction chamber 6.3, the test liquid is aspirated into the liquid tester 6.0.
D: After the approximately 180° rotation of the liquid tester 6.0, the indicator strip 6.4 is no longer bathed by the test liquid.

FIG. 7 shows a fourth exemplary embodiment, the liquid tester 7.0. The fundamental structure of the liquid tester 7.0 is identical to the liquid tester 1.0 and will not be described in further detail.

The striplike indicator 8.0 here is not placed in a separate chamber but instead is fixed in its end region 8.1 between the deep-drawn film 7.1 and the covering film 7.2, so that it protrudes into the reaction chamber 7.3. After the aspiration of the test liquid and ensuing rotation of the liquid tester 7.0 into the vertical position, the indicator strip 8.0 is no longer bathed by the test liquid in its region 8.2 that is equipped with indicators.

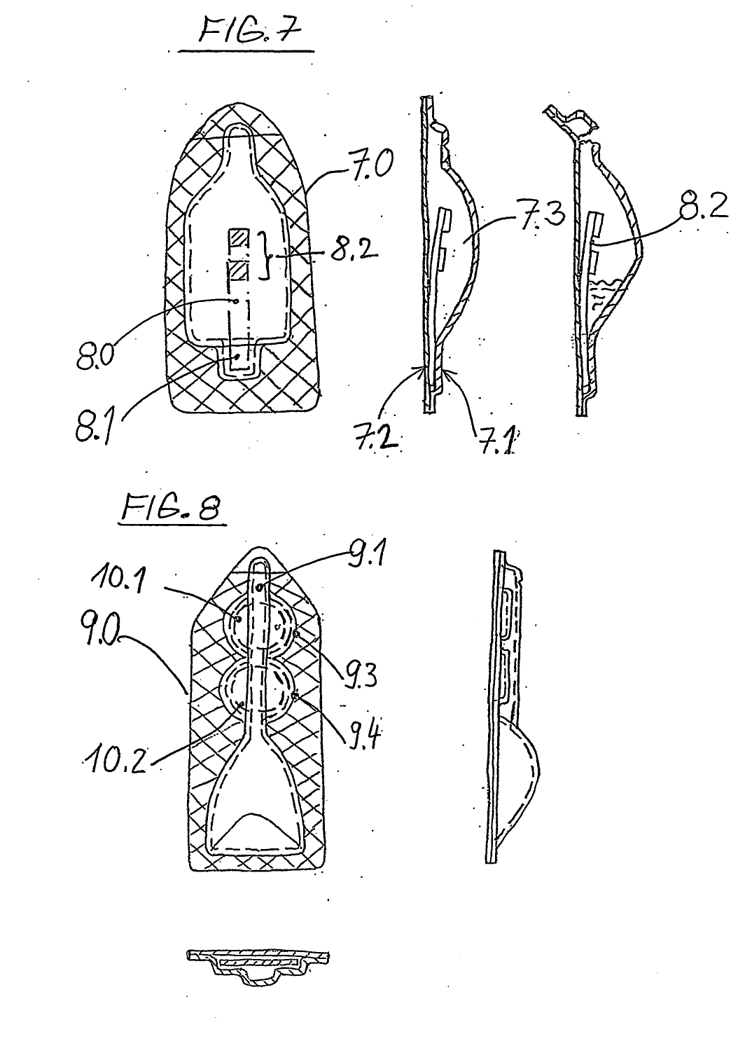

FIG. 8 shows a fifth exemplary embodiment, the liquid tester 9.0. The fundamental structure is equivalent to the liquid tester 1.0 and will not be described in further detail.

In the lengthened region 9.1 of its breakaway tip, the liquid tester 9.0 has two indicator chambers 9.3 and 9.4, which can receive indicators 10.1 or 10.2 of arbitrary form.

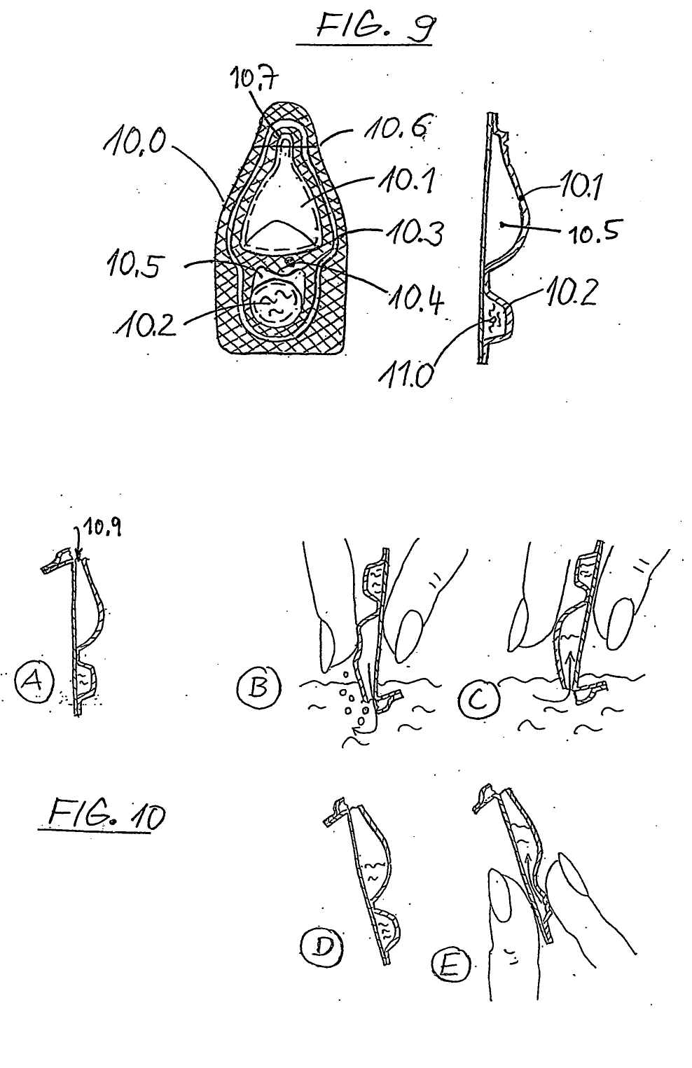

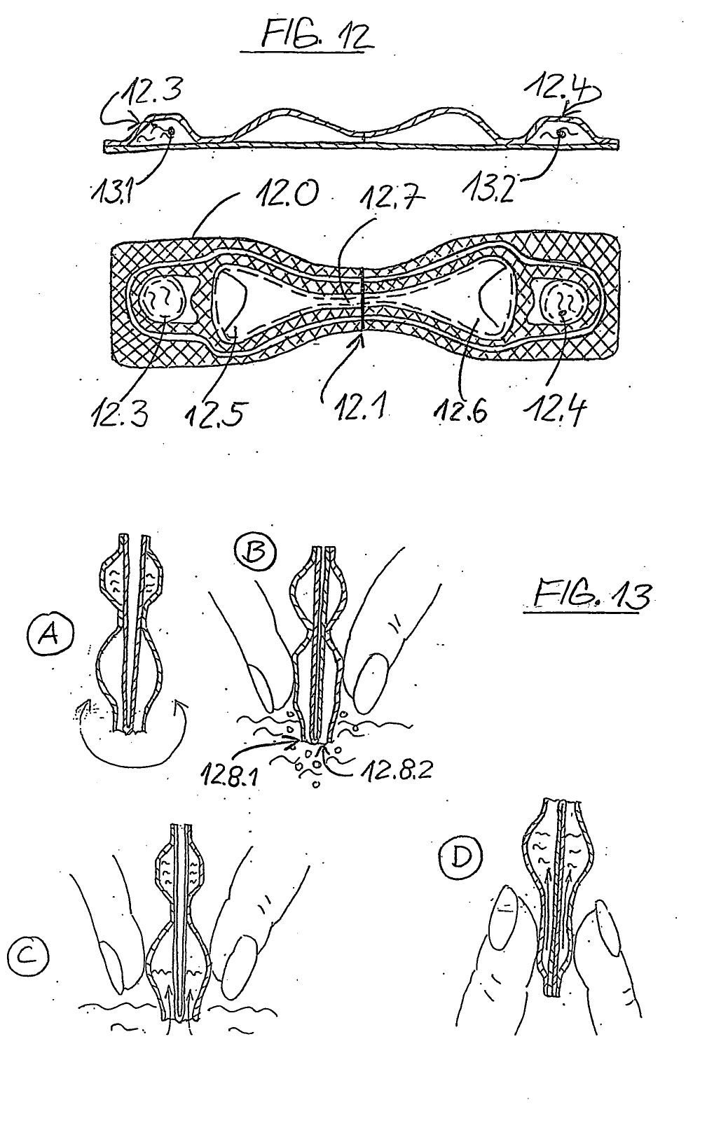

FIG. 9 shows a sixth exemplary embodiment, the liquid tester 10.0. The fundamental structure is equivalent to the liquid tester 1.0 and will not be described in further detail.

The liquid tester 10.0, besides the reaction chamber 10.5 for aspirating the test liquid, also has an indicator chamber 10.2 for receiving a reactant 11.0, which can be in either solid, liquid or powder form. The chambers 10.1 and 10.2 are surrounded by a solid seal 10.3 extending all the way around. Extending between the two chambers is a peelable zone 10.4. To make the package easier to peel open, an unsealed region 10.5 adjoins the indicator chamber 10.2.

FIG. 10 illustrates the use of the liquid tester 10.0.
A: The breakaway tip 10.7 of the liquid tester is broken open along the crease 10.6.
B: The inlet opening 10.9 of the opened breakaway tip 10.7 is kept below the surface of the liquid. Pressure on the reaction chamber 10.1 causes air to escape from the liquid tester 10.0.
C: By the relief of the reaction chamber 10.1, test liquid is aspirated into the reaction chamber 10.1 of the liquid tester 10.0.
D: The liquid tester 10.0 is rotated by approximately 180°.
E: By pressure on the supply chamber 10.2 that contains the reactant 11.0, a communication is established between the reaction chamber 10.1 and the supply chamber 10.2 via the peelable connection 10.4, and a reaction between the test liquid and the reactant 11.0 can now take place.

FIG. 12 shows a seventh exemplary embodiment, the liquid tester 12.0. Its construction is equivalent, except for its rated breaking point 12.1, to the liquid tester 10.0 and will not be described in further detail.

Beyond the rated breaking point 12.1, the liquid tester 12.0 extends in mirror symmetry, forming two indicator chambers 12.3 and 12.4 for receiving different reactants 13.1 and 13.2. The two reaction chambers 12.5 and 12.6 that serve to receive the test liquid are joined together by a common breakaway conduit 12.7 used later for aspirating the test liquid.

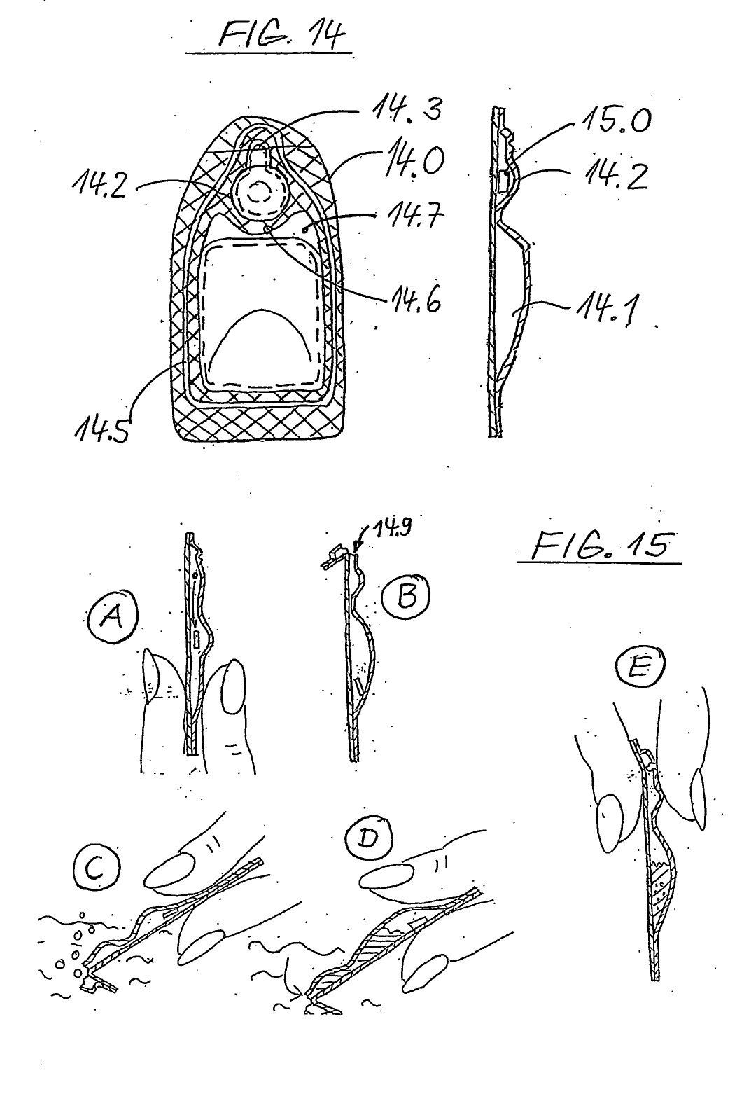

FIG. 13 illustrates the use of the liquid tester 12.0.
A: The liquid tester 12.0 is broken open along its rated breaking point 12.1; the flat sides of the liquid tester 12.0 are folded up against one another.
B: The resultant inlet openings 12.8.1 and 12.8.2 are held below the surface of the liquid. Exerting pressure on the reaction chambers 12.5 and 12.6 simultaneously causes the air to escape from the reaction chambers.
C: With the relief of the reaction chambers 12.5 and 12.6, the test liquid is aspirated into the liquid tester 12.0.
D: After the rotation of the liquid tester by approximately 180°, with simultaneous pressure exerted on the supply chambers 12.3 and 12.4, the peelable connection between the chambers 12.3 and 12.5 and between the chambers 12.4 and 12.6 is undone, so that the reactants 13.1 and 13.2 can react with the test liquid.

FIG. 14 shows an eighth exemplary embodiment, the liquid tester 14.0. In its fundamental construction, the liquid tester 14.0 is equivalent to the liquid tester 1.0 and will not be described in further detail.

The liquid tester 14.0, besides the reaction chamber 14.1 which serves to receive the test liquid, also has an indicator chamber 14.2 for receiving a reactant 15.0. The chambers 14.1 and 14.2 are surrounded by a solid seal 14.5 extending all the way around. Extending between the two chambers is a peelable zone 14.6. An unsealed region 14.7 makes it easier to make the communication between the two chambers by pressing on the reaction chamber 14.1.

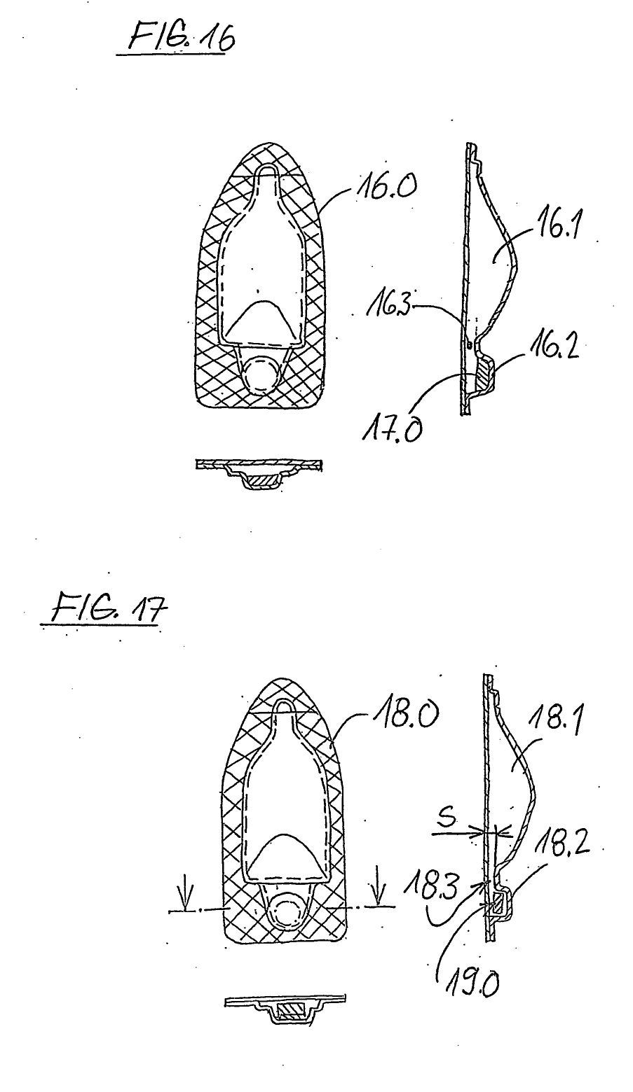

FIG. 15 shows the use of the liquid tester 14.0.
A: Pressing on the reaction chamber 14.1 undoes the peelable connection 14.6 between the chambers 14.1 and 14.2. The reactant 15.0 can slide from the indicator chamber 14.2 into the reaction chamber 14.1.
B: The liquid tester 14.0 is broken open along its rated breaking point 14.3.

C: The inlet opening of the liquid tester 14.0 is kept below the surface of the liquid. Pressing on the reaction chamber 14.1 causes the air to escape from the liquid tester 14.0.
D: With the relief of the reaction chamber 14.1, the test liquid is aspirated into the inlet opening 14.9 of the liquid tester 14.0.
E: The liquid tester 10.0 is rotated by approximately 180°; the reaction can take place.

FIG. 16 shows a ninth exemplary embodiment, the liquid tester 16.0. The fundamental structure is equivalent to the liquid tester 1.0 and will not be described in further detail.

The reaction chamber 16.1 is adjoined by an indicator chamber 16.2, which is suitable for receiving a reactant 17.0 which is in pastelike form or upon introduction is liquid but hardens after that. The chambers 16.1 and 16.2 are open toward one another in the region 16.4, so that in use, the reactant 17.0 can react with the liquid to be tested.

FIG. 17 shows a tenth exemplary embodiment, the liquid tester 18.0. Its construction is equivalent to the liquid tester 16.0.

The reaction chamber 18.1, which serves to receive the test liquid, is adjoined by an indicator chamber 18.2, which receives a reactant 19.0 in solid form. The two chambers are open toward one another in the region 18.3. The indicator chamber 18.2 is designed such that in use, the reactant can be bathed by the test liquid. The gap S at the opening 18.3 is selected such that the reactant 19.0 is firmly retained in the indicator chamber 18.2.

FIG. 18 shows an eleventh exemplary embodiment, the liquid tester 20.0. The fundamental construction is essentially equivalent to the liquid tester 1.0 and will not be described in further detail.

The liquid tester 20.0 has a reaction chamber 21.1, which serves simultaneously to receive the test liquid and (as an indicator chamber) to receive the reactant 21.0. The reactant 21.0 is introduced loosely into the reaction chamber 21.1 and can be either solid, liquid, or applied to substrate material.

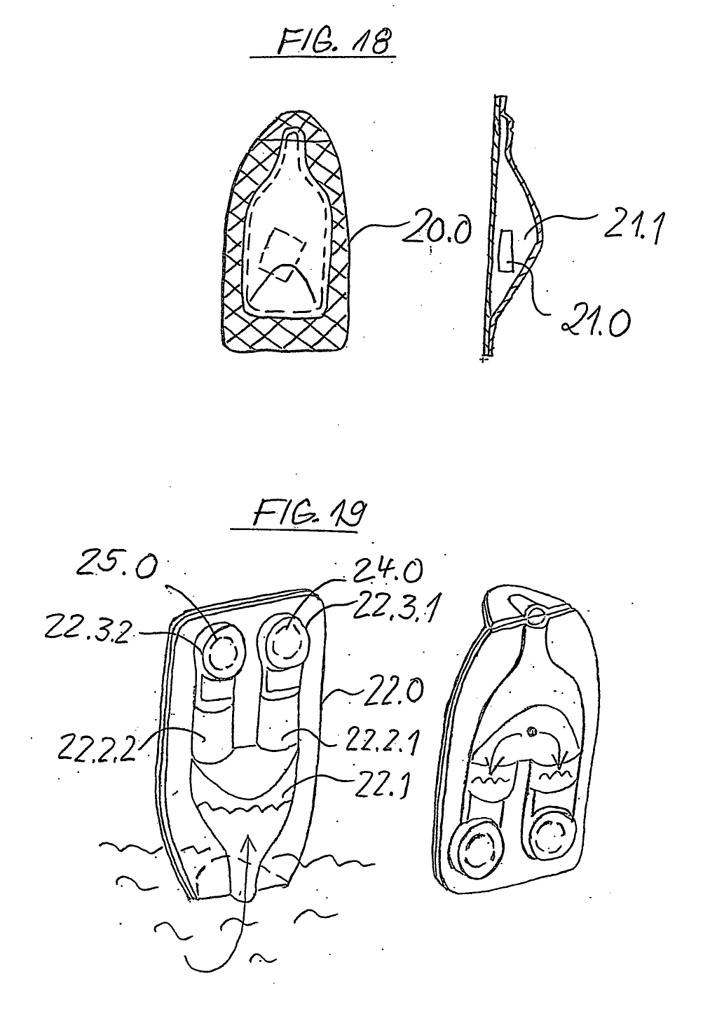

FIG. 19 shows a twelfth exemplary embodiment, the liquid tester 22.0. The fundamental construction is equivalent to the liquid tester 1.0 and will not be described in further detail.

The reaction chamber 22.1 that serves to receive the test liquid is continued in the form of two tubes 22.2.1 and 22.2.2, which are each embodied on their end as respective indicator chambers 22.3.1 and 22.3.2, which receive indicators 24.0 and 25.0 in the form of substrates with a reactant. With the liquid tester 22.0, various measured values of the test liquid can thus be ascertained and displayed simultaneously.

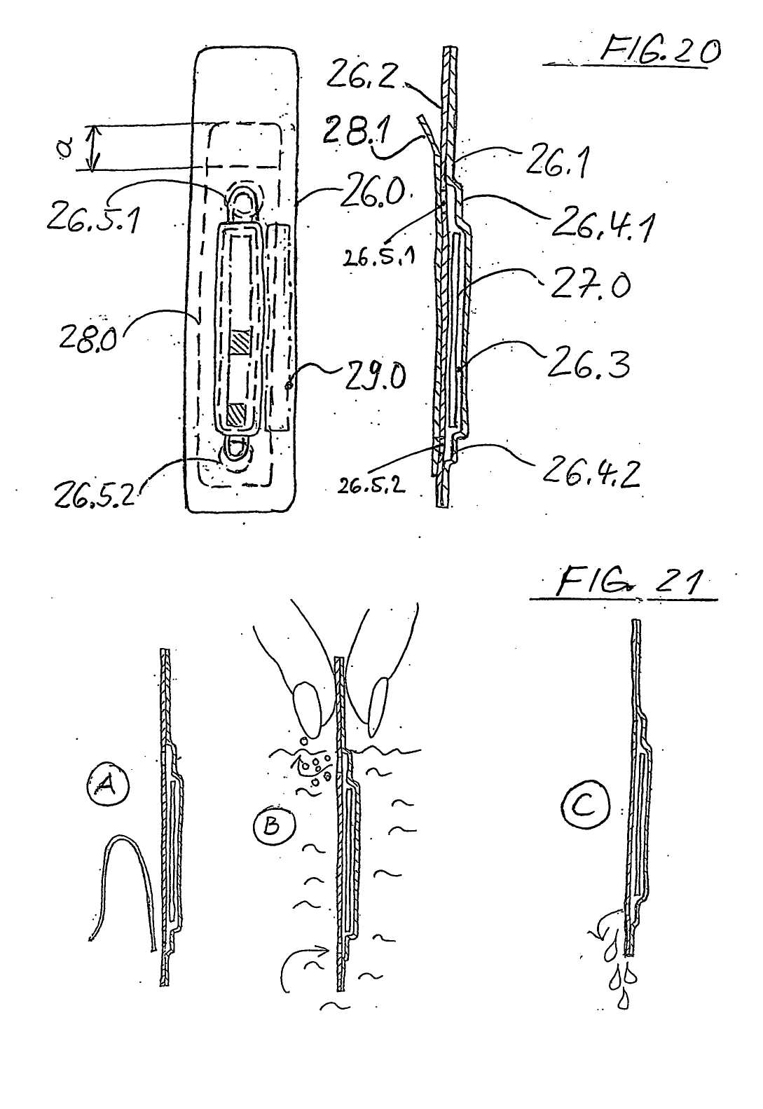

FIG. 20 shows a thirteenth exemplary embodiment, the liquid tester 26.0. The liquid tester 26.0 is composed of a thermoplastically deformed bottom film 26.1 and a sealed-on covering film 26.2. The bottom film is embodied as a reaction chamber 26.3, which receives a striplike indicator 27.0. The reaction chamber 26.3 is lengthened on both ends by conduits 26.4.1 and 26.4.2. In the region of the two conduits 26.4.1 and 26.4.2, the covering film 26.2 is provided with stamped-out features 26.5.1 and 26.5.2, which form two openings 26.5.1 and 26.5.2. Both stamped-out features are covered by an adhesive label 28.0. The region marked -a- of the adhesive label 28.0 is free of adhesive and is embodied as a pull tab 28.1. One or more comparison tables 29.0 are applied to some suitable point.

FIG. 21 shows the use of the liquid tester 26.0.
A: The adhesive label 28.0 is pulled off.
B: The two openings 26.5.1 and 26.5.2 are (or at least one opening is) held in a vertical position below the surface of the liquid. The test liquid can penetrate the liquid tester 26.0 through an opening 26.5.2; simultaneously, the excess air can escape through the other opening 26.5.1.
C: After the liquid tester 26.0 is pulled out of the liquid to be tested, excess liquid can drip out of the liquid tester 26.0. The wetted indicator 27.0 can react.

Because of the two openings, this exemplary embodiment makes do without the suction effect described above, and accordingly the reaction chamber 26.3 need not exert any elastic restoring force.

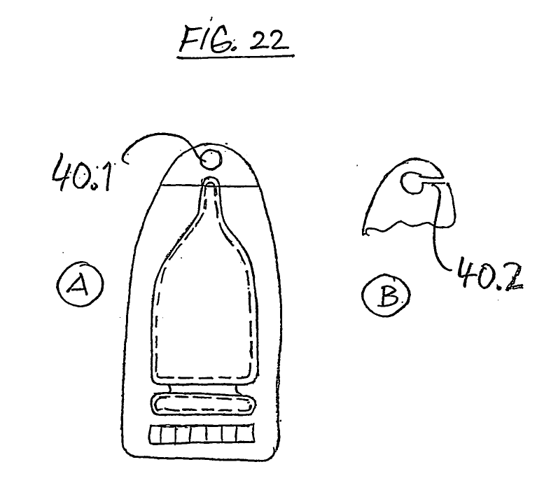

FIG. 22 shows possible ways of hanging up the liquid tester of one of the exemplary embodiments described above:
A: by means of a stamped-out feature 40.1, closed all the way around, in the end region of the liquid tester;
B: by means of a stamped-out feature 40.2 in the end region of the liquid tester, which is open toward the outer edge.

FIG. 23 shows a first possible way of standing up the liquid tester 51.0:

The liquid tester 51.0 is widened by lateral tabs 51.1.1 and 51.1.2 on the side remote from the breakaway tip 51.2 and is demarcated from the breakaway tip by perforations 51.3.1 and 51.3.2. By bending the tabs 51.1.1 and 51.1.2 over along the perforation lines 51.3.1 and 51.3.2, the liquid tester can be made to stand stably in a vertical position.

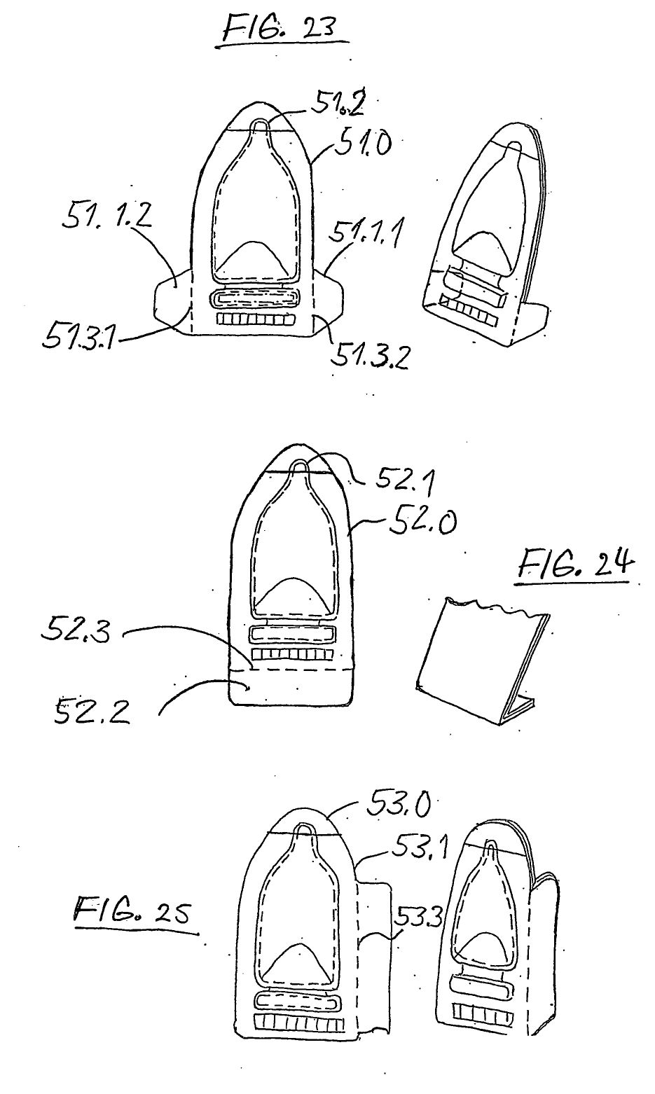

FIG. 24 shows a second possible way of standing up the liquid tester 52.0:

The liquid tester 52.0 is lengthened by a tab 52.2 on the side remote from the breakaway tip 52.1 and is demarcated by a perforation 52.3, which extends perpendicular to the longitudinal axis of the liquid tester 52.0. Folding the tab 52.2 over along the perforation line 52.3 creates a way for the liquid tester to stand up.

FIG. 25 shows a third possible way of standing up the liquid tester 53.0:

The liquid tester 53.0 is widened unilaterally along its side edge 53.1 by a lateral tab 53.2 and is demarcated from the liquid tester by a perforation 53.3. Folding over the tab 53.2 along the perforation line 53.3 creates a stable way of standing up the liquid tester 53.0.

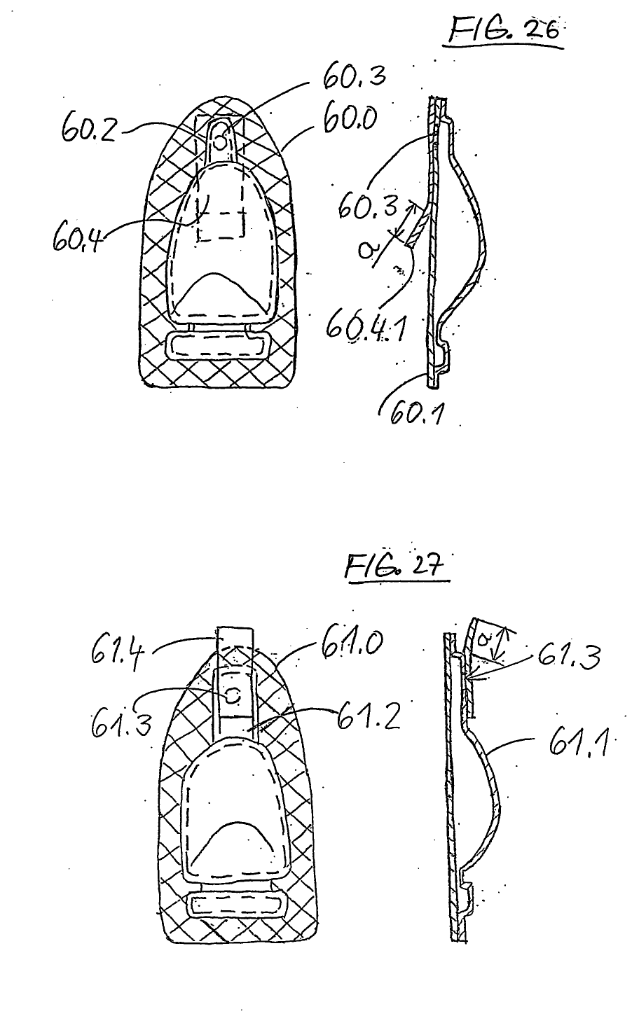

FIG. 26 shows a first variant of an aspiration opening without a rated breaking point, as a fourteenth exemplary embodiment of the liquid tester.

The covering film 60.1 of the liquid tester 60.0, in the region of its aspiration protrusion 60.2, has an inlet opening 60.3, which is covered with an adhesive tab 60.4. The adhesive tab 60.4 is free of adhesive in the region -a- and is embodied as a pull tab 60.4.1. Before use of the liquid tester 60.0, the adhesive tab 60.4 is pulled off.

FIG. 27 shows a second variant of the suction opening without a rated breaking point, as a fifteenth exemplary embodiment.

The bottom film 61.1 of the liquid tester 61.0 is provided, in the region of the aspiration projection 61.2, with a stamped-out feature 61.3. The aspiration projection 61.2 is designed such that it can receive an adhesive label 61.4. The adhesive label 61.4 covers the inlet opening 61.3 and is free of adhesive in its protruding region -a-. Before the water tester 61.0 is put to use, the adhesive label 61.4 is pulled off.

1-15. (canceled)

16. A device for ascertaining and displaying at least one physical, chemical, or biological property of a test liquid or for detecting substances and/or organisms contained therein by reaction with at least one indicator or reactant, said device comprising: at least one deep-drawn cup-shaped element delimiting at least one reaction chamber that has at least one inlet opening for the test liquid; a covering film closing said element; and an indicator or reactant at least partly accessible to, or positioned within, the reaction chamber.

17. The device of claim 16, wherein at least one of the shape and material properties of said reaction chamber is selected such that a temporary reduction of the initial volume of said reaction chamber followed by a restoration of the initial volume generates a restoring effect such that the original shape of said reaction chamber is at least essentially restored, generating a suction action within said reaction chamber.

18. The device of claim 17, wherein the restoring effect is attained by the choice of the shape and properties of the material of said deep-drawn cup-shaped element.

19. The device of claim 16, further comprising an indicator chamber, and wherein said indicator or reactant is a test strip stored in said indicator chamber.

20. The device of claim 19, wherein said test strip is a litmus test strip.

21. The device of claim 19, wherein said indicator chamber is disposed at the opposite side of said reaction chamber from said inlet opening.

22. The device of claim 19, wherein said indicator chamber is disposed between said inlet opening and said reaction chamber.

23. The device of claim 16, wherein said indicator or reactant is at least one liquid that is kept in readiness in said indicator chamber, and said indicator chamber can be made to communicate with said reaction chamber.

24. The device of claim 23, wherein said deep-drawn cup-shaped element and said covering film have a peelable zone via which said reaction chamber and said indicator chamber are joined together.

25. The device of claim 16, wherein said indicator or reactant is at least one solid that is kept in readiness in said indicator chamber, and the test liquid has access to said indicator chamber, or the test liquid can reach said reaction chamber from said indicator chamber.

26. The device of claim 25, wherein said deep-drawn cup-shaped element and said covering film have a peelable zone via which said reaction chamber and said indicator chamber are joined together.

27. The device of claim 25, wherein said indicator or reactant is in the form of a tablet.

28. The device of claim 16, wherein said device has a peripheral region at which said deep-drawn cup-shaped element and said covering film are joined together, and said peripheral region has at least one of recesses and indentations that allow said device to be set upright or hung up.

29. The device of claim 16, further comprising at least one information-carrying medium in the immediate vicinity of said indicator or reactant or of said reaction chamber, wherein said medium shows the possible states of said indicator or reactant after reaction with the test liquid.

30. The device of claim 29, wherein said information-carrying medium shows the colors of said indicator or reactant after reaction with the test liquid.

31. The device of claim 29, wherein said device further comprises a further deep-drawn cup-shaped element that borders on said reaction chamber, and said information-carrying medium is a comparison test strip disposed in said further deep-drawn cup-shaped element.

32. The device of claim 31, further comprising an indicator chamber, and wherein said indicator or reactant is a test strip stored in said indicator chamber.

33. The device of claim 16, wherein: said device further comprises a breakaway tip that can be broken away to expose said inlet opening, said tip is joined to said reaction chamber; and said device further has a line of weakened material between said tip and said reaction chamber.

34. The device of claims 16, wherein: said at least one reaction chamber comprises two reaction chambers; said device further comprises two indicator chambers, each for containing an indicator or reactant; said device defines a common conduit through which said two reaction chambers can communicate; and said device further has a line of weakened material between said two reaction chambers to allow said device to be broken in order to form respective inlet openings to said two reaction chambers.

35. The device of claim 16, wherein said inlet opening is formed by a stamped-out feature, and said device further comprises an adhesive film covering said inlet opening.
